(19) United States
(12) Patent Application Publication
(10) Pub. No.: US 2024/0212456 A1
(43) Pub. Date: Jun. 27, 2024

(54) SERVICE PROVIDING SERVER THAT ENABLES TRANSACTIONS OF NFTS CONTAINING USER PROFILE INFORMATION IN THE TOURNAMENT GAME SERVICE AND OPERATING METHOD THEREOF

(71) Applicant: Supertree Co., Ltd., Seoul (KR)

(72) Inventor: Sung Wone CHOI, Seoul (KR)

(73) Assignee: Supertree Co., Ltd., Seoul (KR)

(21) Appl. No.: 18/540,709

(22) Filed: Dec. 14, 2023

(30) Foreign Application Priority Data
Dec. 21, 2022 (KR) 10-2022-0180000

(51) Int. Cl. G07F 17/32; H04L 9/00; H04L 9/08

(52) U.S. Cl. CPC G07F 17/3276; G07F 17/3237; G07F 17/3244; H04L 9/0825; H04L 9/50; H04L 2209/56

(57) ABSTRACT

Disclosed are a service providing server that enables transactions of non-fungible tokens (NFTs) containing user profile information in a tournament game service and an operating method thereof to support users to enjoy a game while competing in the game in a tournament scheme together with other users in an online environment.

### CROSS-REFERENCE TO RELATED APPLICATIONS

This application claims priority to and the benefit of Korean Patent Application No. 10-2022-0180000 filed in the Korean Intellectual Property Office on Dec. 21, 2022, the entire contents of which are incorporated herein by reference.

### TECHNICAL FIELD

The present disclosure relates to a service providing server that enables transactions of NFTs containing user profile information in the tournament game service and an operating method thereof.

### BACKGROUND ART

Recently, as various electronic terminals including desktop PCs, smart phones, tablet PCs, console game machines, etc., have been released, the number of persons who play games through the electronic terminals has increased.

In particular, the recent electronic terminals provide an environment which enables playing games with others persons through online, in that the electronic terminals enable online connections.

As such, as the environment to play the games with other persons online has widely spread, an interest in the introduction of a new business model using online-based games is also increasing.

Normally, the online-based games are designed to allow people to compete with each other in an online environment, so it is possible to consider introduction of a predetermined tournament service using the online-based games.

For example, by holding a tournament competition using a number of games so that people participate in the tournament of the game they want, the introduction of a business model that pays a certain reward to the winner who wins a specific tournament competition can be considered.

However, in order to provide a tournament platform service using these games, user management technology needs to be introduced, which allows anybody not to participate in the tournament, but allows only the users who qualify for participating in a predetermined tournament to participate in the tournament to improve the quality of the service.

In this regard, the introduction of service technology can be considered, which allows only members having an ability of a specific level or more to participate in the tournament for a specific game by calculating a predetermined level considering a participation record in a tournament, and at the same time, issues a predetermined ticket for participating in the tournament, and allows only the people who purchase this ticket to participate in the tournament of a specific game.

As the use of an NFT has increased recently, it is possible to use the method of issuing and managing a profile of a user who participates in the tournament as the NFT. Here, the non-fungible token (NFT) which means a ‘non-fungible token’ means a virtual asset that is impossible to replace each token with another token because a unique value is given to each token, and the NFT has an advantage of ensuring excellent reliability, and easily providing uniqueness and ownership of contents. In this regard, by including level information calculated according to a tournament participation record of each user and information on the quantity of holding tickets to participate in the tournament in the NFT of each user as profile information, the information is managed through a blockchain to introduce a service which enables more reliable verification of the user's qualifications to participate in the tournament.

A method may also be considered in which by presenting a service technology that allows users to transact these NFTs with each other, even if a user who wants to newly participate in the tournament does not have a required level or a required ticket to participate in the tournament, the user is supported to participate in the tournament in the direction of purchasing of an NFT of another user.

### SUMMARY OF THE INVENTION

The present disclosure has been made in an effort to support users to enjoy a game while competing the game by a tournament scheme jointly with other users in an online environment by presenting a service providing server that enables transactions of non-fungible tokens (NFTs) containing user profile information in a tournament game service and an operating method thereof.

An exemplary embodiment of the present disclosure provides a service providing server which provides a tournament game service that enables a game battle online with other users using tickets, and supports NFTs, wherein in NFTs for a plurality of respective users, profile information of each user is recorded, and at the same time, user identification information for each user is recorded as holder information of the NFT, containing profile information, wherein the profile information of each of the plurality of users contains level information calculated based on a tournament participation record of each user and quantity information of tickets for participating in a tournament, which are held by each user, of each of the plurality of users for using the tournament game service, which is registered in a predetermined blockchain network to be transacted, which includes: a game information storage unit storing information on a required level and information on the number of required tickets for participating in tournaments of a plurality of predetermined respective games; a sales information database storing user identification information for each of the plurality of users and sales price information for the NFT of each user to correspond to each other; an information transmission unit extracting, when a sales information providing request command for a first NFT containing profile information of a second user which is any one of the plurality of users is received from a first electronic terminal of a first user, sales price information for the first NFT from the sales information database, and transmitting the extracted sales price information to the first electronic terminal; a payment processing unit requesting, when a purchase request command for the first NFT is received from the first electronic terminal, transmission of payment means information to the first electronic terminal, and performing, when first payment means information is received from the first electronic terminal, payment processing for an amount according to the sales price information for the first NFT based on the first payment means information; and a transaction registration processing unit requesting transmission of the user identification information for the first user to the first electronic terminal, and generating, when first user identification information is received as the user identification information for the first user from the first electronic terminal, a first transaction containing ownership transfer information indicating changing the user identification information for the second user included in the first NFT as the holder information to the first user identification information, and registering and processing the first transaction in the blockchain network to process the user identification information included in the first NFT registered in the blockchain network to be changed to the first user identification information.

Another exemplary embodiment of the present disclosure provides an operating method of a service providing server which provides a tournament game service that enables a game battle online with other users using tickets, and supports NFTs, wherein in NFTs for a plurality of respective users, profile information of each user is recorded, and at the same time, user identification information for each user is recorded as holder information of the NFT, containing profile information, wherein the profile information of each of the plurality of users contains level information calculated based on a tournament participation record of each user and quantity information of tickets for participating in a tournament, which are held by each user, of each of the plurality of users for using the tournament game service, which is registered in a predetermined blockchain network to be transacted, which includes: maintaining a game information storage unit storing information on a required level and information on the number of required tickets for participating in tournaments of a plurality of predetermined respective games; maintaining a sales information database storing user identification information for each of the plurality of users and sales price information for the NFT of each user to correspond to each other; extracting, when a sales information providing request command for a first NFT containing profile information of a second user which is any one of the plurality of users is received from a first electronic terminal of a first user, sales price information for the first NFT from the sales information database, and transmitting the extracted sales price information to the first electronic terminal; requesting, when a purchase request command for the first NFT is received from the first electronic terminal, transmission of payment means information to the first electronic terminal, and performing, when first payment means information is received from the first electronic terminal, payment processing for an amount according to the sales price information for the first NFT based on the first payment means information; and requesting transmission of the user identification information for the first user to the first electronic terminal, and when first user identification information is received as the user identification information for the first user from the first electronic terminal, generating a first transaction containing ownership transfer information indicating changing the user identification information for the second user included in the first NFT as the holder information to the first user identification information, and registering and processing the first transaction in the blockchain network to process the user identification information included in the first NFT registered in the blockchain network to be changed to the first user identification information.

According to exemplary embodiments of the present disclosure, it is possible to support users to enjoy a game while competing the game by a tournament scheme jointly with other users in an online environment by presenting a service providing server that enables transactions of non-fungible tokens (NFTs) containing user profile information in a tournament game service and an operating method thereof.

### BRIEF DESCRIPTION OF THE DRAWINGS

FIG. 1 is a diagram illustrating a structure of a service providing server according to an exemplary embodiment of the present disclosure.

FIG. 2 is a diagram for describing an operation of a service providing server according to an exemplary embodiment of the present disclosure.

FIG. 3 is a flowchart illustrating an operating method of a service providing server according to an exemplary embodiment of the present disclosure.

### DETAILED DESCRIPTION

Hereinafter, exemplary embodiments of the present disclosure will be described in detail with reference to the accompanying drawings. The description does not limit the present disclosure to specific exemplary embodiments, and it should be understood that the present disclosure covers all the modifications, equivalents and replacements included within the idea and technical scope of the present disclosure. In describing each drawing, like reference numerals refer to like elements and if not contrarily defined, all terms used herein including technological or scientific terms have the same meanings as those generally understood by a person with ordinary skill in the art.

In this document, unless explicitly described to the contrary, the word “comprise” and variations such as “comprises” or “comprising”, will be understood to imply the inclusion of stated elements but not the exclusion of any other elements. Further, in various exemplary embodiments of the present disclosure, each of the components, functional blocks or means may be constituted by one or more lower components and electrical, electronic, and mechanical functions performed by respective components may be implemented as various known devices or mechanical elements including an electronic circuit, an integrated circuit, an Application Specific Integrated Circuit (ASIC), etc., and the respective components may be separately implemented or two or more components may be integrated into one and implemented.

Meanwhile, blocks of the accompanying block diagram or steps of a flowchart may be appreciated as meaning computer program instructions mounted on a processor or a memory of data processible equipment such as a universal computer, a special computer, a portable notebook computer, a network computer, etc., and performing designated functions. Since the computer program instructions may be stored in a memory provided in a computer device or a computer readable memory, functions described in blocks of a block diagram or steps of a flowchart may be produced as a manufactured object including an instruction mean performing the functions. Moreover, each block or each step may represent a part of a module, a segment, or a code that includes one or more executable instructions for executing a specified logical function(s). It should also be noted that in some replaceable embodiments, the functions mentioned in the blocks or steps may also be executed differently from a predetermined order. For example, two blocks or steps that are subsequently illustrated are substantially simultaneously carried out, or may be performed in a reverse order, and in some cases, the functions may be performed while some blocks or steps are omitted.

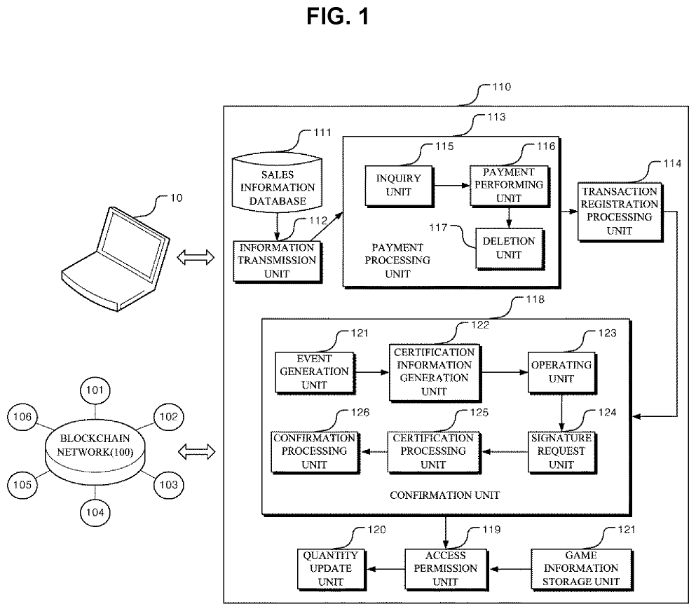

FIG. 1 is a diagram illustrating a structure of a service providing server according to an exemplary embodiment of the present disclosure.

The service providing server 110 according to the present disclosure as a server that provides a tournament game service which enables a game battle online with other users using tickets, and supports to transact NFTs containing profile information of a plurality of respective users for using the tournament game service which are registered in a predetermined blockchain network 100 includes a game information storage unit 121, a sales information database 111, an information transmission unit 112, a payment processing unit 113, and a transaction registration processing unit 114.

First, in the present disclosure, it is assumed that there is a situation in which there is a predetermined blockchain network 100 as illustrated in FIG. 1. In this case, an NFT including profile information of each of a plurality of users for using the tournament game service may be registered in the blockchain network 100.

Here, the profile information of each of the plurality of users may include level information calculated based on a tournament participation record of each user and quantity information of tickets for participating the tournament, which are held by each user. For example, when there is ‘user 1’, profile information of ‘user 1’ may include level information calculated based on a tournament participation record of ‘user 1’ and quantity information of tickets secured for the participating the tournament by ‘user 1’.

Here, the level information means a kind of grade or score calculated based on a predetermined level calculation criterion according to the tournament participation record of the user. For example, when the level calculation criterion is designated so that the level is increased by ‘10 when winning the game by participating in a tournament for a specific game and the level is decreased by ‘5’ when losing the game, and when ‘user 1’ participates in the game, and wins 10 games and loses 5 games, the level of ‘user 1’ may be calculated as ‘75’.

The ticket may be regarded as a kind of token required for the user to participate in the tournament of the specific game, and the user may purchase the ticket for participating in the tournament in an predetermined online store or offline store. When the user purchases the ticket in the online store, purchase history information of the ticket may be configured to be automatically reflected to the profile information of the user. On the contrary, the ticket may be sold in the form of a predetermined gift card in the offline store, and when the user purchases the gift card in the offline store, and then registers the gift card in a computer system, the purchase history information of the ticket may be configured to be reflected on the profile information of the user.

NFTs containing the profile information of the plurality of users may be registered in the blockchain network 100. In this case, the profile information of each user may be recorded in the NFT for each of the plurality of users, and at the same time, user identification information for each user may be recorded as holder information of the NFT.

Here, the user identification information which means unique information for identifying a holder of the NFT may become information such as a wallet address for keeping cryptocurrency pre-issued for each user or a predetermined ID pre-issued for each user for using the tournament game service.

For example, when the profile information of ‘user 1’ is ‘level: 75 and the quantity of holding tickets: 10’, and the user identification information of ‘user 1’ is a wallet address for keeping the cryptocurrency held by ‘user 1’, such as ‘1SASzdfe342sdfsdadZ09dfaawer123sdaf’, ‘1SASzdfe342sdfsdadZ09dfaawer123sdaf’ as the holder information for the NFT may be recorded in the NFT of ‘user 1’ registered in the blockchain network 100 together with profile information which is ‘level: 75 and the quantity of holding tickets: 10’.

The blockchain network 100 may be constituted by a plurality of nodes 101, 102, 103, 104, 105, and 106, and each of the plurality of nodes 101, 102, 103, 104, 105, and 106 stores blockchain data to which blocks containing the NFTs of the plurality of users are connected by the chain. As such, the plurality of nodes 101, 102, 103, 104, 105, and 106 shares the blockchain data to which the blocks containing the NFTs of the respective users are connected by the chain to share the NFTs of the plurality of users. In such a situation, when an NFT containing a profile of a new user is generated, a transaction for registering the NFT in the blockchain network 100 is generated, and in this case, any one node of the plurality of nodes 101, 102, 103, 104, 105, and 106 may generate a block including the transaction and propagate the generated block to the plurality of nodes 101, 102, 103, 104, 105, and 106. As a result, when the block is received in the plurality of nodes 101, 102, 103, 104, 105, and 106, the plurality of nodes 101, 102, 103, 104, 105, and 106 connects the block to blockchain data by a chain based on a previous block connected to blockchain data stored in each node by the chain to share even the NFT of the new user.

In such a situation, the game information storage unit 121 included in the service providing server 110 of the present disclosure stores information on a required level and information on the number of required tickets, for participating in a tournament of each of a plurality of predetermined games.

For example, the game information storage unit 121 may store information shown in Table 1 below.

TABLE 1

| Plurality | | Number of required |
|---|---|---|
| of games | Required level | tickets |
| Game 1 | 60 | 2 |
| Game 2 | 80 | 1 |
| Game 3 | 120 | 5 |
| Game 4 | 200 | 7 |
| . . . | | . . . |

The user identification information for each of the plurality of users and sales price information for the NFT of each user are stored in the sales information database 111 to correspond to each other.

For example, information as shown in Table 2 below may be stored in the sales information database 111.

TABLE 2

| Plurality | User identification | NFT sales price |
|---|---|---|
| of users | information | information |
| User 1 | User identification | 30,000 won |
| | information 1 | |
| User 2 | User identification | 50,000 won |
| | information 2 | |
| User 3 | User identification | 15,000 won |
| | information 3 | |
| User 4 | User identification | 65,000 won |
| | information 4 | |
| . . . | | . . . |

When the information transmission unit 112 receives a sales information providing request command for a first NFT containing profile information of a second user which is any one of the plurality of users from a first electronic terminal 10 of a first user, the information transmission unit 112 may extract sales price information for the first NFT from the sales information database 111, and transmit the sales price information to the first electronic terminal 10.

Then, the first user confirms the sales price information for the first NFT received by the first electronic terminal 10 to determine whether to purchase the first NFT.

In this case, when the service providing server 110 of the present disclosure receives a purchase request command for the first NFT from the first electronic terminal 10, the payment processing unit 113 requests transmission of payment means information to the first electronic terminal 10, and when receiving first payment means information from the first electronic terminal 10, the payment processing unit 113 performs payment processing for an amount according to the sales price information for the first NFT based on the first payment means information.

In this case, according to an exemplary embodiment of the present disclosure, the payment processing unit 113 may include an inquiry unit 115, a payment performing unit 116, and a deletion unit 117.

Upon receiving the purchase request command for the first NFT from the first electronic terminal 10, the inquiry unit 115 extracts the user identification information for the second user from the sales information database 111, and then transmits an inquiry message for inquiring whether to finally purchase the first NFT while transmitting, to the first electronic terminal 10, the profile information recorded in the first NFT by inquiring the first NFT registered in the blockchain network 100 based on the user identification information for the second user.

When the payment performing unit 116 receives a progress command for requesting a final purchase progress in response to the inquiry message from the first electronic terminal 10, the payment performing unit 116 requests transmission of the payment means information to the first electronic terminal 10, and when receiving the first payment means information from the first electronic terminal 10, the payment performing unit 116 performs the payment processing for the amount according to the sales price information for the first NFT based on the first payment means information.

The deletion unit 117 deletes the user identification information of the second user and the sales price information for the first NFT stored in the sales information database 111 when the payment processing is completed.

In this regard, when the sales information database 111 stores the information as in Table 1 above, and the service providing server 110 receives a purchase request command of ‘NFT 3’ for ‘user 3’ from the first electronic terminal 10, the inquiry unit 115 may extract ‘user identification information 3’ for ‘user 3’ from the sales information database 111, and then transmits an inquiry message for inquiring whether to finally purchase ‘NFT 3’ while transmitting profile information recorded in ‘NFT 3’ to the first electronic terminal 10 by inquiring ‘NFT 3’ registered in the blockchain network 100 based on ‘user identification information 3’.

In this case, the inquiry unit 115 may transmit a command for instructing to search the NFT containing holder information such as ‘user identification information 3’ from the blockchain data stored in the node while transmitting ‘user identification information 3’ for any one node of the plurality of nodes 101, 102, 103, 104, 105, and 106 in order to inquire ‘NFT 3’ registered in the blockchain network 100. Then, the node may search ‘NFT 3’ from the blockchain data by using ‘user identification information 3’ as a search word, and in this case, the inquiry unit 115 may extract the profile information for ‘user 3’ recorded inside ‘NFT 3’ searched through the node, and transmit the extracted profile information to the first electronic terminal 10.

As such, when the inquiry message is transmitted to the first electronic terminal 10 together with the profile information for the ‘user 3’, and then the service providing server 110 of the present disclosure receives a progress command for requesting a final purchase progress for ‘NFT 3’ from the first electronic terminal 10 in response to the inquiry message, the payment performing unit 116 may request transmission of the payment means information to the first electronic terminal 10, and when the service providing server 110 receives credit card information from the first electronic terminal 10 in response to the request, the payment performing unit 116 may perform payment processing for ‘15000 won’ based on the credit card information.

Thereafter, the deletion unit 117 may delete the sales price information such as ‘user identification information 3’ and ‘15000 won’ stored in the sales information database 111.

As such, when the payment processing for the first NFT is completed, the transaction registration processing unit 114 requests transmission of the user identification information for the first user to the first electronic terminal 10, and when first user identification information is received as the user identification information for the first user from the first electronic terminal 10, generates a first transaction containing ownership transfer information indicating changing the user identification information for the second user included in the first NFT as the holder information to the first user identification information, and registers and processes the first transaction in the blockchain network 100 to process the user identification information included in the first NFT registered in the blockchain network 100 to be changed to the first user identification information.

In this case, according to an exemplary embodiment of the present disclosure, the transaction registration processing unit 114 may propagate the first transaction to the blockchain network 100 in order to register and process the first transaction in the blockchain network 100. Then, any one node of the plurality of nodes 101, 102, 103, 104, 105, and 106 constituting the blockchain network 100 may generate a block including the first transaction and propagate the generated block to the plurality of nodes 101, 102, 103, 104, 105, and 106. As a result, when the block is received in the plurality of nodes 101, 102, 103, 104, 105, and 106, the plurality of nodes 101, 102, 103, 104, 105, and 106 may change the user identification information for the second user included in the first NFT included in the blockchain data stored in each node to the first user identification information based on the first transaction on the received block.

Through this, the plurality of nodes 101, 102, 103, 104, 105, and 106 may share the NFT in which the holder information of the first NFT is changed to the first user identification information, and as a result, the ownership of the first NFT is transferred from the second user to the first user.

An operator of the service providing server 110 according to the present disclosure may hold a tournament competition for each of the plurality of games in order to provide the tournament game service, and in this case, the operator may open a tournament session of each of the plurality of games online in order to allow the users to participate in the tournament competition for each of the plurality of games online through electronic terminals held by the members.

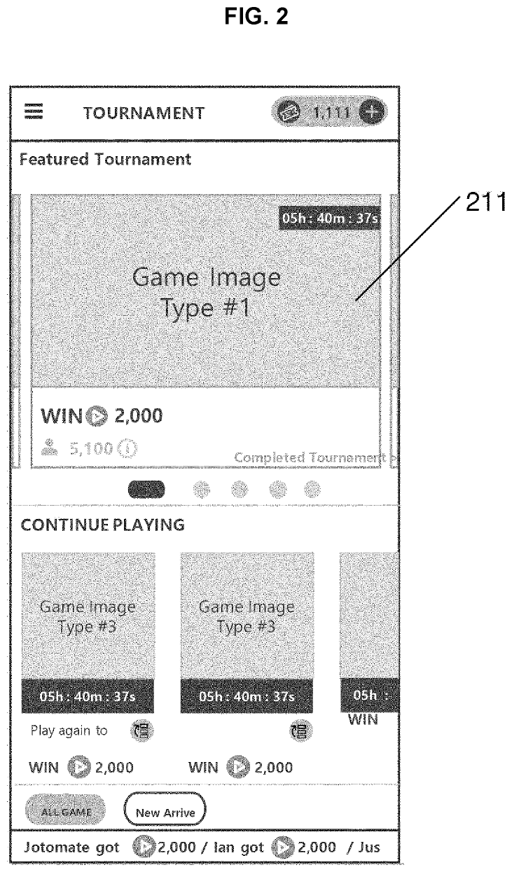

In this regard, FIG. 2 is a diagram illustrating an example of a screen in which when a specific user accesses the service providing server 110 through an electronic terminal thereof, a tournament session of each of the plurality of games is opened, which may be viewed through the electronic terminal. Here, when reference numeral 211 of FIG. 2 represents a screen in which a tournament session for a first game which is any one of the plurality of games is opened, the tournament session means a session opened so as for users who access the tournament session to play the first game online together through the electronic terminal. That is, multiple users access the tournament session through electronic terminals thereof to play the first game jointly with each other online.

As a result, the first user who purchases the first NFT accesses the service providing server 110 through the first electronic terminal 10 thereof to view a waiting room screen having a Ul illustrated in FIG. 2.

In this case, when the first user clicks on the tournament session for the first game represented by reference numeral 211 through the first electronic terminal 10, the first electronic terminal 10 may transmit, to the service providing server 110 of the present disclosure, an access request command to the tournament session.

In this case, according to an exemplary embodiment of the present disclosure, the service providing server 110 as a component for processing an access request command to the tournament session received from the first electronic terminal 10 may further include a confirmation unit 118 and an access permission unit 119.

When the confirmation unit 118 receives an access request command to a tournament session (the tournament session means a session opened for users accessing the tournament session through the electronic terminal to play the first game jointly online) opened for a first game which is any one of the plurality of games, from the first electronic terminal 10 after the registration processing of the first transaction in the blockchain network 100 is completed, the confirmation unit 118 requests transmission of the user identification information for the first user, to the first electronic terminal 10, and when receiving the first user identification information from the first electronic terminal 10, the confirmation unit 118 inquires the first NFT registered in the blockchain network 100 based on the first user identification information, and confirms first level information and first ticket quantity information included in the profile information recorded in the first NFT.

In this case, the confirmation unit 118 may transmit a command for instructing to search the NFT containing holder information such as the first user identification information from the blockchain data stored in the node while transmitting the first user identification information for any one node of the plurality of nodes 101, 102, 103, 104, 105, and 106 in order to inquire the first NFT registered in the blockchain network 100. Then, the node may search the first NFT from the blockchain data by using the first user identification information as the search word, and in this case, the confirmation unit 118 confirms the profile information recorded inside the first NFT searched through the node to confirm the first level information and the first ticket quantity information.

The access permission unit 119 confirms a first required level which is a required level for participating in the tournament of the first game, and a first required number which is the number of required tickets for participating in the tournament of the first game, by referring to the game information storage unit 121, and then when it is confirmed that a level according to the first level information is equal to or more than the first required level and at the same time, it is confirmed that the quantity of holding tickets according to the first ticket quantity information is equal to or more than the first required number, the access permission unit 119 permits the access of the first electronic terminal 10 to the tournament session to process the first electronic terminal 10 to access the tournament session.

In this regard, when it is assumed that information is stored in the game information storage unit 111 as in Table 1 above, the first game is referred to as ‘game 2’, the first level information included in the profile information in the first NFT is designated as ‘90’, and the first ticket quantity information is designated as ‘15’, the level and the quantity of holding tickets of the first user are equal to or more than the first required level and the first required number for participating in the tournament of ‘game 2’, so the access permission unit 119 permits the first electronic terminal 10 to access the tournament session for ‘game 2’ to process the first electronic terminal 10 to access the tournament session.

Through this, the first user accesses the tournament session for the first game by using the first electronic terminal 10 to play the first game jointly with other users who access the tournament session in the form of the tournament online.

In this case, according to an exemplary embodiment of the present disclosure, the service providing server 110 may further include a quantity update unit 120.

When the access of the first electronic terminal 10 to the tournament session is permitted, the quantity update unit 120 generates a second transaction indicting that the first user expends the tickets of the first required number, and registers and processes the second transaction in the blockchain network 100 to process the first ticket quantity information in the profile information recorded in the first NFT registered in the blockchain network 100 the first NFT to be reduced and updated by the first required number.

In this regard, as in the above-described example, as the first electronic terminal 10 accesses the tournament session for ‘game 2’, when the first required number is ‘1’, the quantity update unit 120 generates a second transaction indicating that the first user expends a ticket of ‘1’ which is the first required number, and registers and processes the second transaction in the blockchain network 100 to process the first ticket quantity information in the first NFT registered in the blockchain network 100 to be reduced and updated from ‘15’ to ‘14’.

In this case, according to an exemplary embodiment of the present disclosure, the quantity update unit 120 may propagate the second transaction to the blockchain network 100 in order to register and process the second transaction in the blockchain network 100. Then, any one node of a plurality of nodes 101, 102, 103, 104, 105, and 106 constituting the blockchain network 100 may generate a block including the second transaction and propagate the generated block to the plurality of nodes 101, 102, 103, 104, 105, and 106. As a result, when the block is received in the plurality of nodes 101, 102, 103, 104, 105, and 106, the plurality of nodes 101, 102, 103, 104, 105, and 106 may reduce and update the first ticket quantity information in the first NFT included in the blockchain data stored in each node from ‘15’ to ‘14’ based on the second transaction on the received block.

In this case, according to an exemplary embodiment of the present disclosure, upon receiving the access request command to the tournament session opened for the first game from the first electronic terminal 10, the service providing server 110 performs the certification for the first user, and then only when it is confirmed that the first user is a certified member, the service providing server 110 may further include a configuration of conducting a process for determining whether to allow the first electronic terminal 10 to access the tournament session based on the ticket held by the first user.

In this regard, the transaction registration processing unit 114 may include a component which stores predetermined certification information for certifying the first user in a member database (not illustrated) afterward in the process of completing purchase processing of the first NFT of the first user.

In this regard, when the first transaction is registered and processed in the blockchain network 100 as the ownership of the first NFT is transferred from the second user to the first user, the transaction registration processing unit 114 may request transmission of a public key for verifying the electronic signature and e-mail address information held by the first user to the first electronic terminal 10.

In this case, it is assumed that a predetermined first private key for an electronic signature and a first public key corresponding thereto are pre-stored in the first electronic terminal 10. As a result, when the first electronic terminal 10 receives a transmission request of the public key and the e-mail address information from the service providing server 110 of the present disclosure, the first electronic terminal 10 may receive, from the first user, information on a first e-mail address according to an account of the first user, and then, transmit, to the service providing server 110 of the present disclosure, the first public key stored in the first electronic terminal 10, and the information on the first e-mail address received from the first user.

As such, when the service providing server 110 of the present disclosure receives the first public key corresponding to the first private key pre-stored in the first electronic terminal 10, and the information on the first e-mail address from the first electronic terminal 10, the transaction registration processing unit 114 may store, in the member database, the first user identification information, and the first public key and the information on the first e-mail address to correspond to each other.

In this case, according to an exemplary embodiment of the present disclosure, the confirmation unit 118 as a component for conducting user certification may include an event generation unit 121, a certification information generation unit 122, an operating unit 123, a signature request unit 124, a certification processing unit 125, and a confirmation processing unit 126.

The event generation unit 121 generates a certification event for conducting e-mail based user certification for the first user when receiving the access request command to the tournament session opened for the first game from the first electronic terminal 10.

The certification information generation unit 122 randomly generates, when the certification event is generated, a n (n is a natural number of 2 or more)-digit first certification number, randomly generates a certification value constituted by a natural number having a size of 9 or less, and then, performs a modulo operation having the certification value as a divisor for respective digit numbers constituting the first certification number to generate an n-digit second certification number.

For example, when it is assumed that n is ‘3’, the certification information generation unit 122 randomly generates a 3-digit first certification number as ‘642’, randomly generates the certification value as ‘5’, and then performs a modulo operation having ‘5’ which is the certification value as the divisor for “6′, ‘4’, and ‘2’ which are respective digit numbers constituting the first certification number to generate a 3-digit second certification number as ‘142’.

The operating unit 123 generates a column vector having respective digit numbers constituting the first certification number as components and a row vector having respective digit numbers constituting the second certification number as components, and operates a matrix multiplication between the column vector and the row vector to generate an operation matrix of an n×n size, and then operates Frobenius Norm of the operation matrix.

Here, Frobenius Norm means L2-Norm that represents the size of the matrix.

In this regard, as in the above-described example, when the first certification number is generated as ‘642’ and the second certification number is generated as ‘142’ through the certification information generation unit 122, the operating unit 123 generates a column vector having respective digit numbers constituting ‘642’ which is the first certification number as components as

$$‘ [ \begin{matrix}6 \\ 4 \\ 2\end{matrix} ] ’ ,$$

generates a row vector having respective digit numbers constituting ‘142’ which is the second certification number as components as ‘[1 4 2]’, and then operates the matrix multiplication between the column vector and the row vector to generate an operation matrix having a size of 3×3 as

$$‘ [ \begin{matrix}6 & 24 & 12 \\ 4 & 16 & 8 \\ 2 & 8 & 4\end{matrix} ] ’ ,$$

and operate Frobenius Norm of the operation matrix.

The signature request unit 124 requests transmission of the user identification information for the first user to the first electronic terminal 10, and when receiving the first user identification information from the first electronic terminal 10, confirms the first e-mail address stored to correspond to the first user identification information from the member database, sends a certification e-mail including the first certification number with the first e-mail address as a receiver, and then transmits the certification value to the first electronic terminal 10, and at the same time, requests the electronic signature based on the first certification number and the certification value.

For example, as in the above-described example, when the first certification number and the certification value are set to ‘642’ and ‘5’, respectively, the signature request unit 124 may request the transmission of the identification information for identifying the first user to the first electronic terminal 10, and when receiving the first user identification information from the first electronic terminal 10, confirms the first e-mail address stored to correspond to the first user identification information from the member database, and then send a certification e-mail including ‘642’ which is the first certification number with the first e-mail address as the receiver. Then, the signature request unit 124 may transmit ‘5’ which is the certification value to the first electronic terminal 10, and at the same time, request the electronic signature based on the first certification number and the certification value.

In this case, according to an exemplary embodiment of the present disclosure, upon receiving the electronic signature request from the service providing server 110 jointly with the certification value, the first electronic terminal 10 may display a message for requesting the first user to input the first certification number included in the certification e-mail received by an account according to the first e-mail address into the first electronic terminal 10.

In this case, when the first user inputs, into the first electronic terminal 10, the first certification number included in the certification e-mail received by the account according to the first e-mail address in response to the message, the first electronic terminal 10 performs the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and operates the matrix multiplication between the column vector and the row vector to generate the operation matrix of the n×n size, and then sign the Frobenius Norm of the operation matrix with the first private key for the first user stored in the first electronic terminal 10 to generate a first electronic signature value, and transmit the generated first electronic signature value to the service providing server 110 of the present disclosure.

In this regard, as in the above-described example, when the first certification number and the certification value are ‘642’ and ‘5’, respectively, the first electronic terminal 10 may display a message for requesting the first user to input the first certification number included in the certification e-mail received by the account according to the first e-mail address into the first electronic terminal 10 when receiving the electronic signature request from the service providing server 110 jointly with ‘5’ which is the certification value.

Then, the first user logs into the account according to the first e-mail address to confirm the certification e-mail, and confirms ‘642’ which is the first certification number included in the certification e-mail to input ‘642’ which is the first certification number into the first electronic terminal 10.

As such, when the first user inputs ‘642’ which is the first certification number included in the certification e-mail into the first electronic terminal 10, the first electronic terminal 10 performs a modulo operation having ‘5’ which is the certification value as the divisor for “6′, ‘4’, and ‘2’ which are respective digit numbers constituting the first certification number to generate a 3-digit second certification number as ‘142’.

Then, the first electronic terminal 10 generates a column vector having respective digit numbers constituting ‘642’ which is the first certification number as components as

$$‘ [ \begin{matrix}6 \\ 4 \\ 2\end{matrix} ] ’$$

and generates a row vector having respective digit numbers constituting ‘142’ which is the second certification number as components as ‘[1 4 2]’, and then operates the matrix multiplication between the column vector and the row vector to generate an operation matrix of a 3×3 size as

$$‘ [ \begin{matrix}6 & 24 & 12 \\ 4 & 16 & 8 \\ 2 & 8 & 4\end{matrix} ] ’ .$$

Thereafter, the first electronic terminal 10 operates the Frobenius Norm of the operation matrix, and then performs the electronic signature for the Frobenius Norm based on the first private key pre-stored in the first electronic terminal 10 to generate the first electronic signature value and transmit the first electronic signature value to the service providing server 110 of the present disclosure.

Upon receiving the first electronic signature value in response to the electronic signature request from the first electronic terminal 10, the certification processing unit 125 extracts the first public key stored to correspond to the first user identification information from the member database, and then compares a value acquired by decoding the first electronic signature value based on the first public key and the Frobenius Norm of the operation matrix with each other, and when it is confirmed that both values coincide with each other, completes the certification for the first user.

When the certification for the first user is completed, the confirmation processing unit 126 inquires the first NFT registered in the blockchain network 100 based on the first user identification information to confirm the first level information and the first ticket quantity information included in the profile information recorded in the first NFT.

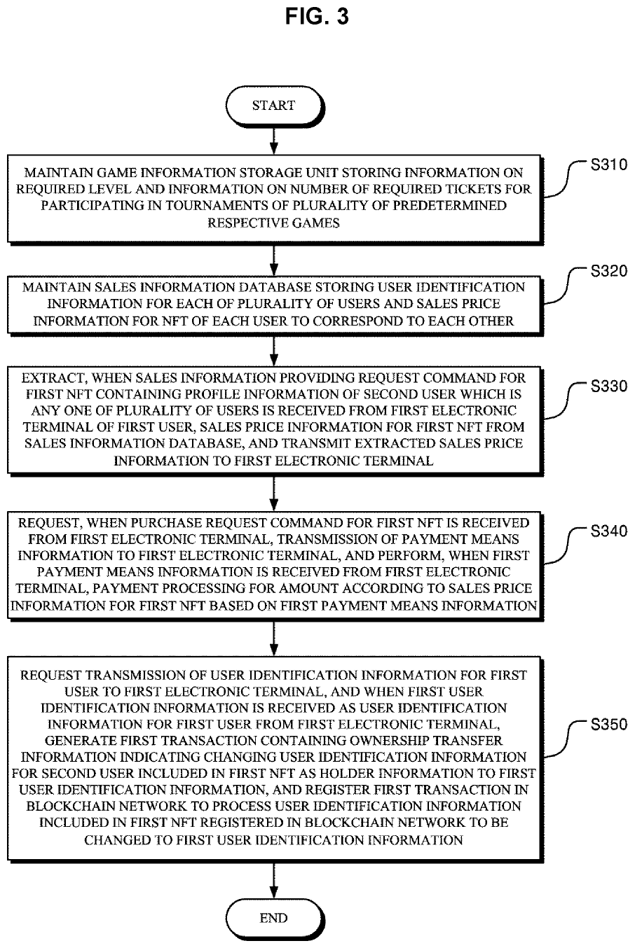

FIG. 3 is a flowchart illustrating an operating method of a service providing server which provides a tournament game service that enables a game battle online with other users using tickets according to an exemplary embodiment of the present disclosure, and supports NFTs (in NFTs for a plurality of respective users, profile information of each user is recorded, and at the same time, user identification information for each user is recorded as holder information of the NFT) containing profile information (the profile information of each of the plurality of users contains level information calculated based on a tournament participation record of each user and quantity information of tickets for participating in a tournament, which are held by each user) of each of the plurality of users for using the tournament game service, which is registered in a predetermined blockchain network to be transacted.

In step S310, a game information storage unit is maintained, which stores information on a required level and information on the number of required tickets for participating in tournaments of a plurality of predetermined respective games.

In step S320, a sales information database is maintained, which stores user identification information for each of the plurality of users and sales price information for the NFT of each user to correspond to each other.

In step S330, when a sales information providing request command for a first NFT containing profile information of a second user which is any one of the plurality of users is received from a first electronic terminal of a first user, sales price information for the first NFT is extracted from the sales information database, and transmitted to the first electronic terminal.

In step S340, when a purchase request command for the first NFT is received from the first electronic terminal, transmission of payment means information is requested to the first electronic terminal, and when first payment means information is received from the first electronic terminal, payment processing is performed for an amount according to the sales price information for the first NFT based on the first payment means information.

In step S350, transmission of the user identification information for the first user is requested to the first electronic terminal, and when first user identification information is received as the user identification information for the first user from the first electronic terminal, a first transaction containing ownership transfer information indicating changing the user identification information for the second user included in the first NFT as the holder information to the first user identification information is generated, and the first transaction is registered and processed in the blockchain network to process the user identification information included in the first NFT registered in the blockchain network to be changed to the first user identification information.

In this case, according to an exemplary embodiment of the present disclosure, step S340 may include extracting, upon receiving the purchase request command for the first NFT from the first electronic terminal, the user identification information for the second user from the sales information database, and then transmitting an inquiry message for inquiring whether to finally purchase the first NFT while transmitting, to the first electronic terminal, the profile information recorded in the first NFT by inquiring the first NFT registered in the blockchain network based on the user identification information for the second user, requesting, upon receiving a progress command for requesting a final purchase progress in response to the inquiry message from the first electronic terminal, transmission of the payment means information to the first electronic terminal, and performing, upon receiving the first payment means information from the first electronic terminal, the payment processing for the amount according to the sales price information for the first NFT based on the first payment means information, and deleting the user identification information of the second user and the sales price information for the first NFT stored in the sales information database when the payment processing is completed.

According to an exemplary embodiment of the present disclosure, the operating method of the service providing server may further include requesting, when receiving an access request command to a tournament session (the tournament session means a session opened for users accessing the tournament session through the electronic terminal to play the first game jointly online) opened for a first game which is any one of the plurality of games from the first electronic terminal after the registration processing of the first transaction in the blockchain network is completed, transmission of user identification information for the first user, to the first electronic terminal, and when receiving the first user identification information from the first electronic terminal, inquiring the first NFT registered in the blockchain network based on the first user identification information, and confirming first level information and first ticket quantity information included in the profile information recorded in the first NFT, and confirming a first required level which is a required level for participating the tournament of the first game by referring to the game information storage unit and confirming a first required number which is the number of required tickets for participating in the tournament of the first game, and then when it is confirmed that the level according to the first level information is equal to or more than the first required level, and at the same time, the quantity of holding tickets according to the first ticket quantity information is equal to or more than the first required number, permitting the first electronic terminal to access the tournament session to process the first electronic terminal to access the tournament session.

In this case, according to an exemplary embodiment of the present disclosure, the operating method of the service providing server may further include, when the access of the first electronic terminal to the tournament session is permitted, generating a second transaction indicting that the first user expends the tickets of the first required number, and registering and processing the second transaction in the blockchain network to process the first ticket quantity information in the profile information recorded in the first NFT registered in the blockchain network to be reduced and updated by the first required number.

According to an exemplary embodiment of the present disclosure, in step S350, when the first transaction is registered and processed in the blockchain network, a purchase completion message indicating that the purchase of the first NFT is completed is transmitted to the first electronic terminal, and then transmission of a public key for electronic signature verification and e-mail address information held by the first user is requested to the first electronic terminal, and when the first public key corresponding to the first private key pre-stored in the first electronic terminal, and the information on the first e-mail address are received from the first electronic terminal, the first user identification information, and the first public key and the information on the first e-mail address may be stored in the member database to correspond to each other.

In this case, the confirming may include generating a certification event for conducting e-mail based user certification for the first user when receiving the access request command to the tournament session opened for the first game from the first electronic terminal, randomly generating, when the certification event is generated, an n (n is a natural number of 2 or more)-digit first certification number, randomly generating a certification value constituted by a natural number having a size of 9 or less, and then, performing a modulo operation having the certification value as a divisor for respective digit numbers constituting the first certification number to generate an n-digit second certification number, generating a column vector having respective digit numbers constituting the first certification number as components and a row vector having respective digit numbers constituting the second certification number as components, and operating a matrix multiplication between the column vector and the row vector to generate an operation matrix of an n×n size, and then operating Frobenius Norm of the operation matrix, requesting transmission of user identification information for the first user to the first electronic terminal, and when receiving the first user identification information from the first electronic terminal, confirming the first e-mail address stored to correspond to the first user identification information from the member database, sending a certification e-mail including the first certification number with the first e-mail address as a receiver, and then transmitting the certification value to the first electronic terminal, and at the same time, requesting the electronic signature based on the first certification number and the certification value, when receiving a first electronic signature value (the first electronic signature value is generated by performing, when the certification value is received in the first electronic terminal, and the first user inputs the first certification number included in the certification e-mail received by an account according to the first e-mail address into the first electronic terminal, by the first electronic terminal, the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and operating the matrix multiplication between the column vector and the row vector to generate the operation matrix of the n×n size, and then signing the Frobenius Norm of the operation matrix with the first private key stored in the first electronic terminal) from the first electronic terminal in response to the electronic signature request, extracting the first public key stored to correspond to the first user identification information from the member database, and then comparing a value acquired by decoding the first electronic signature value based on the first public key and the Frobenius Norm of the operation matrix with each other, and when it is confirmed that both values coincide with each other, completing the certification for the first user, and when the certification for the first user is completed, inquiring the first NFT registered in the blockchain network based on the first user identification information to confirm the first level information and the first ticket quantity information included in the profile information recorded in the first NFT.

Hereinabove, referring to FIG. 3, the operating method of the service providing server according to an exemplary embodiment of the present disclosure is described. Here, since the operating method of the service providing server according to an exemplary embodiment of the present disclosure may correspond to the configuration of the operation of the service providing server 110 described by using FIGS. 1 and 2, a more detailed description thereof will be omitted.

The operating method of the service providing server according to an exemplary embodiment of the present disclosure may be implemented by a computer program stored in a storage medium for executing the computer program through combination with a computer.

The operating method of the service providing server according to an exemplary embodiment of the present disclosure may be implemented in a program command type which may be performed through various computer means and recorded in a computer readable medium. The computer readable medium may include a program command, a data file, a data structure, etc., singly or combinationally. The program command recorded in the medium may be specially designed and configured for the present disclosure, or may be publicly known to and used by those skilled in the computer software field. An example of the computer readable recording medium includes magnetic media, such as a hard disk, a floppy disk, and a magnetic tape, optical media such as a CD-ROM and a DVD, magneto-optical media such as a floptical disk, and hardware devices such as a ROM, a RAM, and a flash memory, which are specially configured to store and execute the program command. An example of the program command includes a high-level language code executable by a computer by using an interpreter and the like, as well as a machine language code created by a compiler.

As described above, the present disclosure has been described by specified matters such as detailed components, and the like and limited exemplary embodiments and drawings, but the description is just provided to assist more overall understanding of the present disclosure and the present disclosure is not limited to the exemplary embodiment and various modifications and changes can be made by those skilled in the art from such a disclosure.

Accordingly, the spirit of the present disclosure should not be defined only by the described exemplary embodiments, and it should be appreciated that claims to be described below and all things which are equivalent to the claims or equivalently modified to the claims are included in the scope of the spirit of the present disclosure.

What is claimed is:

1. A service providing server which provides a tournament game service that enables a game battle online with other users using tickets, and supports NFTs, wherein in NFTs for a plurality of respective users, profile information of each user is recorded, and at the same time, user identification information for each user is recorded as holder information of the NFT, containing profile information, wherein the profile information of each of the plurality of users contains level information calculated based on a tournament participation record of each user and quantity information of tickets for participating in a tournament, which are held by each user, of each of the plurality of users for using the tournament game service, which is registered in a predetermined blockchain network to be transacted, comprising:
a game information storage unit storing information on a required level and information on the number of required tickets for participating in tournaments of a plurality of predetermined respective games;
a sales information database storing user identification information for each of the plurality of users and sales price information for the NFT of each user to correspond to each other;
an information transmission unit extracting, when a sales information providing request command for a first NFT containing profile information of a second user which is any one of the plurality of users is received from a first electronic terminal of a first user, sales price information for the first NFT from the sales information database, and transmitting the extracted sales price information to the first electronic terminal;
a payment processing unit requesting, when a purchase request command for the first NFT is received from the first electronic terminal, transmission of payment means information to the first electronic terminal, and performing, when first payment means information is received from the first electronic terminal, payment processing for an amount according to the sales price information for the first NFT based on the first payment means information; and
a transaction registration processing unit requesting transmission of the user identification information for the first user to the first electronic terminal, and generating, when first user identification information is received as the user identification information for the first user from the first electronic terminal, a first transaction containing ownership transfer information indicating changing the user identification information for the second user included in the first NFT as the holder information to the first user identification information, and registering the first transaction in the blockchain network to process the user identification information included in the first NFT registered in the blockchain network to be changed to the first user identification information.

2. The service providing server of claim 1, wherein the payment processing unit includes
an inquiry unit extracting, upon receiving the purchase request command for the first NFT from the first electronic terminal, the user identification information for the second user from the sales information database, and then transmitting an inquiry message for inquiring whether to finally purchase the first NFT while transmitting to the first electronic terminal the profile information recorded in the first NFT by inquiring the first NFT registered in the blockchain network based on the user identification information for the second user,
a payment performing unit requesting, upon receiving a progress command for requesting a final purchase progress in response to the inquiry message from the first electronic terminal, transmission of the payment means information to the first electronic terminal, and performing, when receiving the first payment means information from the first electronic terminal, the payment processing for the amount according to the sales price information for the first NFT based on the first payment means information, and
a deletion unit deleting the user identification information of the second user and the sales price information for the first NFT stored in the sales information database when the payment processing is completed.

3. The service providing server of claim 1, further comprising:
a confirmation unit requesting, when receiving an access request command to a tournament session, wherein the tournament session means a session opened for users accessing the tournament session through the electronic terminal to play the first game jointly online, opened for a first game which is any one of the plurality of games, from the first electronic terminal after the registration processing of the first transaction in the blockchain network is completed, transmission of user identification information for the first user, to the first electronic terminal, and when receiving the first user identification information from the first electronic terminal, inquiring the first NFT registered in the blockchain network based on the first user identification information, and confirming first level information and first ticket quantity information included in profile information recorded in the first NFT; and
an access permission unit confirming a first required level which is a required level for participating in the tournament of the first game, and a first required number which is the number of required tickets for participating in the tournament of the first game, by referring to the game information storage unit, and then when it is confirmed that a level according to the first level information is equal to or more than the first required level and at the same time, it is confirmed that the quantity of holding tickets according to the first ticket quantity information is equal to or more than the first required number, permitting the first electronic terminal to access the tournament session to process the first electronic terminal to access the tournament session.

4. The service providing server of claim 3, further comprising:
a quantity update unit generating, when the access of the first electronic terminal to the tournament session is permitted, a second transaction indicting that the first user expends the tickets of the first required number, and registering the second transaction in the blockchain network to process the first ticket quantity information in the profile information recorded in the first NFT registered in the blockchain network to be reduced and updated by the first required number.

5. The service providing server of claim 3, wherein when the first transaction is registered in the blockchain network, the transaction registration processing unit transmits a purchase completion message indicating that the purchase of the first NFT is completed to the first electronic terminal, and then requests transmission of a public key for electronic signature verification and e-mail address information held by the first user to the first electronic terminal, and when a first public key corresponding to a first private key pre-stored in the first electronic terminal, and the information on a first e-mail address are received from the first electronic terminal, stores the first user identification information, and the first public key and the information on the first e-mail address in the member database to correspond to each other, and
the confirmation unit includes
an event generation unit generating a certification event for conducting e-mail based user certification for the first user when receiving the access request command to the tournament session opened for the first game from the first electronic terminal,
a certification information generation unit randomly generating, when the certification event is generated, a n, wherein n is a natural number of 2 or more, digit first certification number, randomly generating a certification value constituted by a natural number having a size of 9 or less, and then, performing a modulo operation having the certification value as a divisor for respective digit numbers constituting the first certification number to generate an n-digit second certification number,
an operating unit generating a column vector having respective digit numbers constituting the first certification number as components and a row vector having respective digit numbers constituting the second certification number as components, and operating a matrix multiplication between the column vector and the row vector to generate an operation matrix of an n×n size, and then operating Frobenius Norm of the operation matrix,
a signature request unit requesting transmission of user identification information for the first user to the first electronic terminal, and when receiving the first user identification information from the first electronic terminal, confirming the first e-mail address stored to correspond to the first user identification information from the member database, sending a certification e-mail including the first certification number with the first e-mail address as a receiver, and then transmitting the certification value to the first electronic terminal, and at the same time, requesting the electronic signature based on the first certification number and the certification value,
a certification processing unit extracting, when receiving a first electronic signature value, wherein the first electronic signature value is generated by performing, when the certification value is received in the first electronic terminal, and the first user inputs the first certification number included in the certification e-mail received by an account according to the first e-mail address into the first electronic terminal, by the first electronic terminal, the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and operating the matrix multiplication between the column vector and the row vector to generate the operation matrix of the n×n size, and then signing the Frobenius Norm of the operation matrix with the first private key stored in the first electronic terminal, from the first electronic terminal in response to the electronic signature request, the first public key stored to correspond to the first user identification information from the member database, and then comparing a value acquired by decoding the first electronic signature value based on the first public key and the Frobenius Norm of the operation matrix with each other, and when it is confirmed that both values coincide with each other, completing the certification for the first user, and
a confirmation processing unit inquiring, when the certification for the first user is completed, the first NFT registered in the blockchain network based on the first user identification information to confirm the first level information and the first ticket quantity information included in the profile information recorded in the first NFT.

6. An operating method of a service providing server which provides a tournament game service that enables a game battle online with other users using tickets, and supports NFTs, wherein in NFTs for a plurality of respective users, profile information of each user is recorded, and at the same time, user identification information for each user is recorded as holder information of the NFT, containing profile information, wherein the profile information of each of the plurality of users contains level information calculated based on a tournament participation record of each user and quantity information of tickets for participating in a tournament, which are held by each user, of each of the plurality of users for using the tournament game service, which is registered in a predetermined blockchain network to be transacted, comprising:
maintaining a game information storage unit storing information on a required level and information on the number of required tickets for participating in tournaments of a plurality of predetermined respective games;
maintaining a sales information database storing user identification information for each of the plurality of users and sales price information for the NFT of each user to correspond to each other;
extracting, when a sales information providing request command for a first NFT containing profile information of a second user which is any one of the plurality of users is received from a first electronic terminal of a first user, sales price information for the first NFT from the sales information database, and transmitting the extracted sales price information to the first electronic terminal;
requesting, when a purchase request command for the first NFT is received from the first electronic terminal, transmission of payment means information to the first electronic terminal, and performing, when first payment means information is received from the first electronic terminal, payment processing for an amount according to the sales price information for the first NFT based on the first payment means information; and
requesting transmission of the user identification information for the first user to the first electronic terminal, and when first user identification information is received as the user identification information for the first user from the first electronic terminal, generating a first transaction containing ownership transfer information indicating changing the user identification information for the second user included in the first NFT as the holder information to the first user identification information, and registering the first transaction in the blockchain network to process the user identification information included in the first NFT registered in the blockchain network to be changed to the first user identification information.

7. The operating method of claim 6, wherein the requesting of the transmission of payment means information includes
extracting, upon receiving the purchase request command for the first NFT from the first electronic terminal, the user identification information for the second user from the sales information database, and then transmitting an inquiry message for inquiring whether to finally purchase the first NFT while transmitting to the first electronic terminal the profile information recorded in the first NFT by inquiring the first NFT registered in the blockchain network based on the user identification information for the second user,
requesting, upon receiving a progress command for requesting a final purchase progress in response to the inquiry message from the first electronic terminal, transmission of the payment means information to the first electronic terminal, and performing, when receiving the first payment means information from the first electronic terminal, the payment processing for the amount according to the sales price information for the first NFT based on the first payment means information, and
deleting the user identification information of the second user and the sales price information for the first NFT stored in the sales information database when the payment processing is completed.

8. The operating method of claim 6, further comprising:
requesting, when receiving an access request command to a tournament session, wherein the tournament session means a session opened for users accessing the tournament session through the electronic terminal to play the first game jointly online, opened for a first game which is any one of the plurality of games, from the first electronic terminal after the registration processing of the first transaction in the blockchain network is completed, transmission of user identification information for the first user, to the first electronic terminal, and when receiving the first user identification information from the first electronic terminal, inquiring the first NFT registered in the blockchain network based on the first user identification information, and confirming first level information and first ticket quantity information included in profile information recorded in the first NFT; and
confirming a first required level which is a required level for participating in the tournament of the first game, and a first required number which is the number of required tickets for participating in the tournament of the first game, by referring to the game information storage unit, and then when it is confirmed that a level according to the first level information is equal to or more than the first required level and at the same time, it is confirmed that the first quantity of holding tickets according to the first ticket quantity information is equal to or more than the first required number, permitting the first electronic terminal to access the tournament session to process the first electronic terminal to access the tournament session.

9. The operating method of claim 8, further comprising:
generating, when the access of the first electronic terminal to the tournament session is permitted, a second transaction indicting that the first user expends the tickets of the first required number, and registering the second transaction in the blockchain network to process the first ticket quantity information in the profile information recorded in the first NFT registered in the blockchain network to be reduced and updated by the first required number.

10. The operating method of claim 8, further comprising:
when the first transaction is registered in the blockchain network, transmitting a purchase completion message indicating that purchase of the first NFT is completed to the first electronic terminal, and then requesting transmission of a public key for electronic signature verification and e-mail address information held by the first user to the first electronic terminal, and when a first public key corresponding to the first private key pre-stored in the first electronic terminal, and the information on a first e-mail address are received from the first electronic terminal, storing the first user identification information, and the first public key and the information on the first e-mail address in the member database to correspond to each other, and
the requesting of the transmission of user identification information includes
generating a certification event for conducting e-mail based user certification for the first user when receiving the access request command to the tournament session opened for the first game from the first electronic terminal,
randomly generating, when the certification event is generated, a n, wherein n is a natural number of 2 or more, digit first certification number, randomly generating a certification value constituted by a natural number having a size of 9 or less, and then, performing a modulo operation having the certification value as a divisor for respective digit numbers constituting the first certification number to generate an n-digit second certification number,
generating a column vector having respective digit numbers constituting the first certification number as components and a row vector having respective digit numbers constituting the second certification number as components, and operating a matrix multiplication between the column vector and the row vector to generate an operation matrix of an n×n size, and then operating Frobenius Norm of the operation matrix,
requesting transmission of user identification information for the first user to the first electronic terminal, and when receiving the first user identification information from the first electronic terminal, confirming the first e-mail address stored to correspond to the first user identification information from the member database, sending a certification e-mail including the first certification number with the first e-mail address as a receiver, and then transmitting the certification value to the first electronic terminal, and at the same time, requesting the electronic signature based on the first certification number and the certification value,
performing, when receiving a first electronic signature value, wherein the first electronic signature value is generated by performing, when the certification value is received in the first electronic terminal, and the first user inputs the first certification number included in the certification e-mail received by an account according to the first e-mail address into the first electronic terminal, by the first electronic terminal, the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and operating the matrix multiplication between the column vector and the row vector to generate the operation matrix of the n×n size, and then signing the Frobenius Norm of the operation matrix with the first private key stored in the first electronic terminal, from the first electronic terminal in response to the electronic signature request, the first public key stored to correspond to the first user identification information from the member database, and then comparing a value acquired by decoding the first electronic signature value based on the first public key and the Frobenius Norm of the operation matrix with each other, and when it is confirmed that both values coincide with each other, completing the certification for the first user, and
inquiring, when the certification for the first user is completed, the first NFT registered in the blockchain network based on the first user identification information to confirm the first level information and the first ticket quantity information included in the profile information recorded in the first NFT.

11. A non-transitory computer readable recording medium having a program recorded therein for allowing a computer to execute an operating method of a service providing server which provides a tournament game service that enables a game battle online with other users using tickets, and supports NFTs, wherein in NFTs for a plurality of respective users, profile information of each user is recorded, and at the same time, user identification information for each user is recorded as holder information of the NFT, containing profile information, wherein the profile information of each of the plurality of users contains level information calculated based on a tournament participation record of each user and quantity information of tickets for participating in a tournament, which are held by each user, of each of the plurality of users for using the tournament game service, which is registered in a predetermined blockchain network to be transacted, comprising:
maintaining a game information storage unit storing information on a required level and information on the number of required tickets for participating in tournaments of a plurality of predetermined respective games;
maintaining a sales information database storing user identification information for each of the plurality of users and sales price information for the NFT of each user to correspond to each other;
extracting, when a sales information providing request command for a first NFT containing profile information of a second user which is any one of the plurality of users is received from a first electronic terminal of a first user, sales price information for the first NFT from the sales information database, and transmitting the extracted sales price information to the first electronic terminal;
requesting, when a purchase request command for the first NFT is received from the first electronic terminal, transmission of payment means information to the first electronic terminal, and performing, when first payment means information is received from the first electronic terminal, payment processing for an amount according to the sales price information for the first NFT based on the first payment means information; and
requesting transmission of the user identification information for the first user to the first electronic terminal, and when first user identification information is received as the user identification information for the first user from the first electronic terminal, generating a first transaction containing ownership transfer information indicating changing the user identification information for the second user included in the first NFT as the holder information to the first user identification information, and registering the first transaction in the blockchain network to process the user identification information included in the first NFT registered in the blockchain network to be changed to the first user identification information.
